(19) United States
(12) Patent Application Publication
(10) Pub. No.: US 2002/0131444 A1
(43) Pub. Date: Sep. 19, 2002

(54) Communications system with database management

(76) Inventors: Justin Charles Moodie, London (GB); Matthew Peter Travers, London (GB); Adedayo Elegbe, London (GB)

Correspondence Address: Gary S. Morris, Kenyon & Kenyon, Suite 700, 1500 K Street N.W., Washington, DC, 20005, US

(21) Appl. No.: 09/803,928

(22) Filed: Mar. 13, 2001

(51) Int. Cl. H04L 12/66; G06F 17/30; G06F 7/00

(52) U.S. Cl. 370/463; 707/10

(57) ABSTRACT

A database system is accessible via multiple communications channel types so as to store data entered by users, retrieve the data, and/or to retrieve lists of data according to codes entered by the users. Preferably, the data can be retrieved over wireless channels so that it is available wherever it is needed. In one example, the data comprises a shopping list or list of recipes. Alternatively, the system may be used for collecting or transferring data or performing transactions according to codes transmitted by users over a wireless network. An advantage of this system is that codes may be displayed with advertising material and users may enter codes when they see the advertising material so as to register their interest, obtain more information or conduct a transaction.

### FIELD OF THE INVENTION

The present invention relates to a system, method, computer program and apparatus for enabling users to add entries to a personal database and/or to receive information based on entries in a personal database, wherein the database is preferably accessible over multiple different types of communications channels.

### BACKGROUND OF THE INVENTION

The popularity of mobile telephones and other digital communication devices has led to various commercial applications in which users send messages to the network based on information they have obtained on the move and receive a service based on that information. For example, the SCANTM system allows users to send product codes of items such as books or recordings as Short Message Service (“SMS”) messages, receive price quotes for the items, and order the items via their mobile devices.

### SUMMARY OF THE INVENTION

In accordance with an embodiment of the present invention, a database system is provided that is accessible via multiple communications channel types so as to store data entered by users, retrieve the data, and/or to store and retrieve lists of data according to codes entered by the users. Preferably, the data can be retrieved over wireless channels so that it is available wherever it is needed. In one example, the data comprises a shopping list or list of recipes.

A system can also be provided for collecting or transferring data or performing transactions according to codes transmitted by users over a wireless network. An advantage of this system is that codes may be displayed with advertising material and users may enter codes when they see the advertising material so as to register their interest, obtain more information or conduct a transaction.

### BRIEF DESCRIPTION OF THE DRAWINGS

Specific embodiments of the present invention will now be described with reference to the accompanying drawings, in which:

FIG. 1 is a schematic diagram showing shopping list management functions in an embodiment of the invention;

FIG. 2 is a schematic diagram showing recipe management functions in the embodiment of the invention;

FIG. 3 shows some operations which can be performed using the web interface of the embodiment;

FIG. 4 is a schematic layout diagram of a web page generated by the web interface;

FIG. 5 shows some operations which can be performed using the SMS interface of the embodiment; and

FIG. 6 is a diagram of the database schema in the embodiment.

### DETAILED DESCRIPTION OF PREFERRED EMBODIMENTS

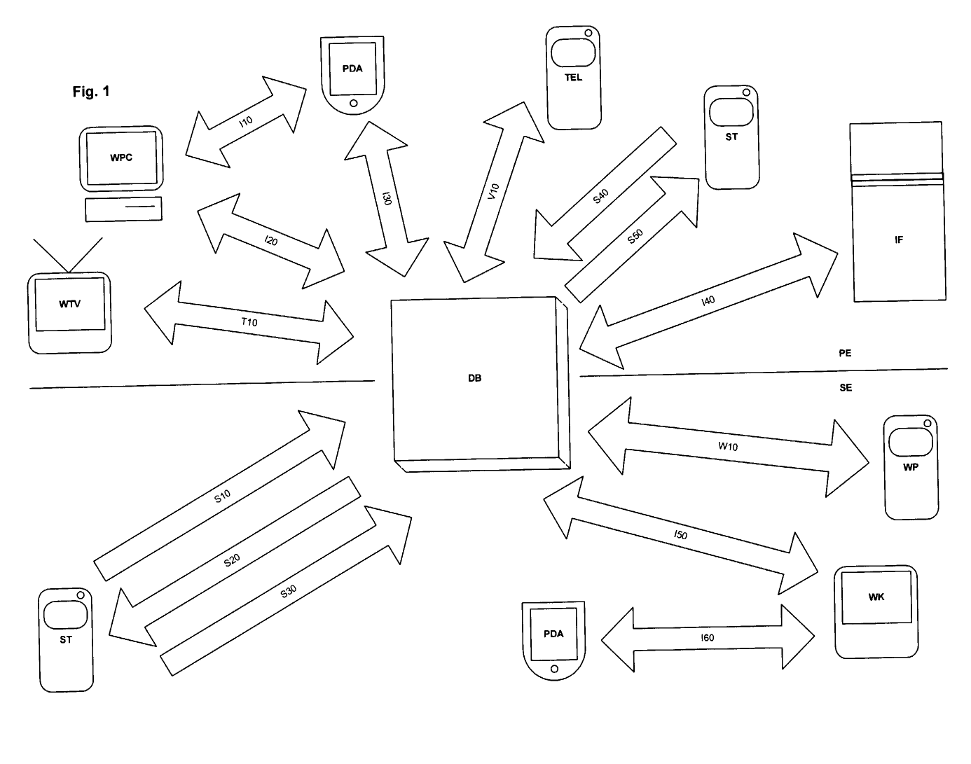

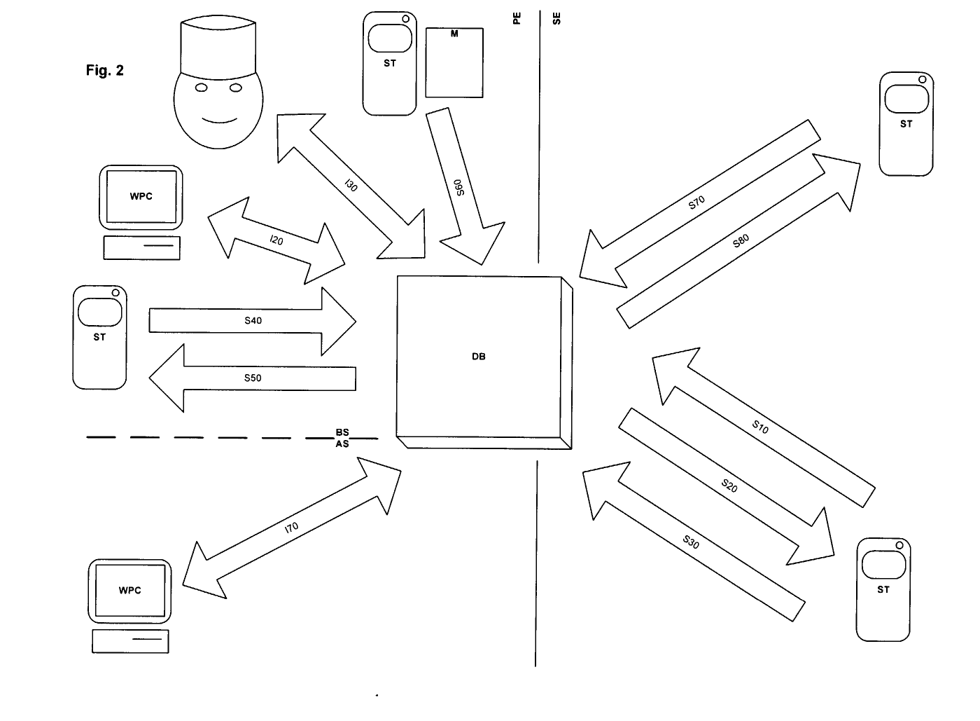

In an embodiment of the present invention, access to a common database DB is provided via multiple communications channels to provide shopping list management functions, as shown in FIG. 1, and recipe management functions, as shown in FIG. 2.

The common database DB is stored on a database server, for example using SQL Server. The interface between the database and the communications channels are provided by an SMS server, a web server, a Wireless Access Protocol (“WAP”) server, an interactive television (“TV”) server and a voice server; these may be distributed amongst different physical server computers or one or more of them may be collocated on the same server.

The common database DB stores, for each user, a database of information which is compiled in response to instructions and/or information sent by the user over one or more of the communications channels. The database may also be interrogated by the user using some or all of these communications channels. In the specific embodiment, the database relates to shopping list and recipe items, but this is only one example of an application of the database.

The diagram of FIG. 1 is divided into planning environment functions PE and shopping environment functions SE. In the planning environment, the user adds shopping list items to their personal database, using one or more of the communication channels described below.

The user may use a web-enabled interactive television WTV to access (T10) a site on the interactive TV server or web server. Items available for selection are displayed and may be added to the database by filling in check boxes. Alternatively or additionally, a text search may be performed for the desired items, which are then selected for addition to the shopping list.

The user may compile a shopping list on a mobile computer such as a personal digital assistant PDA or on a web-enabled personal computer WPC, and the shopping list may be synchronized (I10) between the two. The shopping list may be transmitted to the database DB either via the personal computer WPC (I20) or the PDA (I30).

The user may call a specified number on any conventional telephone TEL to access (V10) the voice server, which runs voice recognition software. The user enters an identity code, either by voice or by dialing numbers, and dictates items to the voice server for addition to their personal database. The items may be repeated back to the user by means of speech synthesis software, for confirmation of the order.

The user may send (S40) an SMS message from an SMS-enabled mobile telephone ST to a designated number of the SMS server. The SMS message contains the command ‘ADD’ followed by a list of items, delimited by commas. The SMS server responds (S50) with a message confirming that the items have been added to the user's personal database. The user is identified automatically by the SMS server from the user's number which is transmitted automatically as part of the SMS message.

The user may add items to the shopping list by means of an internet-enabled refrigerator IF or other device, incorporating a barcode scanner. The user scans the barcode on the packaging of an item to be reordered, the refrigerator IF accesses (I40) the database over the Internet and transmits the bar code data together with a prestored code identifying the user. The bar code data may be converted to other data identifying the item using a lookup table, so that the data identifying the item is stored in a standard format.

In the shopping environment SE, the user accesses the database DB to retrieve their shopping list, using any one or more of the communications channels described below.

Using the SMS-enabled telephone ST, the user may send (S10) an SMS message including the command ‘LIST’ to the designated number of the SMS server. The SMS server retrieves the list of items from the user's personal database and transmits (S20) the list of items to the telephone ST in one or more SMS messages, depending on the total length of the message. The SMS server then deletes the list of items from the database DB. If any items are not purchased, the user must resubmit them (S30), using the ‘ADD’ command as in step S40.

The user may access (W10) the shopping list on the personal database using a WAP-enabled mobile telephone WP. The list is displayed using WAP protocols and the user may select which items to delete from the list. This option is useful when the user only has time to buy key items.

The user may use a web-enabled kiosk WK to access (I50) their personal database to display and modify their shopping list. The user swipes a card through a card-reader on the kiosk WK to provide identifying information, which is then used to gain access to the user's personal database. The kiosk WK may be located within a retail outlet and the card may be a loyalty card for the retail outlet. The user may download (I60) the list of items onto their PDA so that it can be viewed while shopping. The PDA may use a short-range local wireless communication system such as Bluetooth™ to interact with transmitters, positioned around a store, which broadcast the items available in their vicinity. An application running on the PDA compares the broadcast items to the items on the stored shopping list and alerts the user when there is a match, preferably by highlighting the items on the shopping list which match.

FIG. 2 shows some of the shopping list management functions, using the same reference numerals, and also shows recipe management functions as will now be described.

The common database contains records of recipes which are supplied (I30) by content providers. Each record includes one or more short identifying phrases (e.g. ‘Thai chicken’), a list of ingredients for that recipe and instructions for the recipe, optionally including one or more video clips.

In the planning environment PE, before shopping (BS), the user may send (S60) an SMS message to the SMS server containing a code identifying a specific recipe stored on the database. For example, the recipe may be printed in a magazine M together with an identifying code. The database server fetches the corresponding recipe record and adds that record to a list of favorites in the user's personal database. Optionally, depending on the command entered with the code in the SMS message, the ingredients for the specific recipe may be added to the user's shopping list.

The use of identifying codes or ‘offline bookmarks’ to add one or more items to the user's personal database may be extended to other scenarios. For example, the user may view a cookery demonstration on an interactive television and select an option to order the ingredients for the recipe being demonstrated, for example by clicking a button on a remote control. The identifying code is received by the interactive television as part of the broadcast and is submitted to the central database DB in response to the user's order; the user does not have to enter the code explicitly. This function is not limited to the ordering of ingredients and may be used in conjunction with broadcast advertisements to order or indicate an interest in the item being advertised.

The ‘offline bookmark’ may be used to operate an electronic coupon scheme. In response to the user transmitting, either implicitly or explicitly, the code of an item to the database DB, a coupon code may be entered into the user's personal database. The coupon code may be retrieved by the user and redeemed using the kiosk WK to print a paper coupon or manually on presentation of the coupon code at a retail outlet. The coupon code may be related to the identity of the user, such as their loyalty card number, to prevent the user from forwarding the code to others for their own use. The coupon code may include a time stamp to restrict the period within which it can be used.

The ‘offline bookmark’ may be used to make purchases with online retailers who hold prestored account and ordering details for the user. The user simply enters the identifying code and sends it in an SMS message to the SMS server. The SMS server retrieves the user's account and ordering details using the identifying code and the user's mobile number, and initiates a transaction to purchase and preferably to deliver the ordered item to the user. The SMS server may first send an SMS message to the user giving details of the transaction and requesting confirmation to proceed, to which the user responds with a confirmation SMS message to allow the transaction to proceed. Alternatively, the transaction may proceed without the confirmation request and response.

The ‘offline bookmark’ may be used to quickly request detailed information based on advertisements. For example, the user may see a health insurance advertisement which includes an identity code. The user sends an SMS message containing the identity code to the SMS server. The SMS server retrieves the user's and advertiser's details stored in the database DB and referenced using the identity code and the user's mobile number from which the message was sent. The user's address is then sent to the advertiser so that they can forward the detailed information to the user. Alternatively, the detailed information may be stored electronically on a database and forwarded as an email to the user.

In the shopping environment SE, the user may send (S70) an SMS message to the SMS server containing the identifying phrase for a desired recipe. The database server returns the list of ingredients from the corresponding recipe record, and the list is transmitted (S80) to the user's SMS-enabled mobile phone ST. Alternatively, using a different command, the list of ingredients may be added to the user's shopping list and the shopping list may then be retrieved.

After shopping (AS), the user may access (I70) the common database using a web-enabled personal computer WPC, to retrieve instructions from the recipe record which the user has previously accessed, at either steps S60 or S70. Alternatively, the instructions may be accessed over an interactive television. The instructions may include a series of video clips corresponding to stages in the execution of the recipe. Each video clip is displayed in turn under the user's control, so that each stage may be carried out before proceeding to the next video clip.

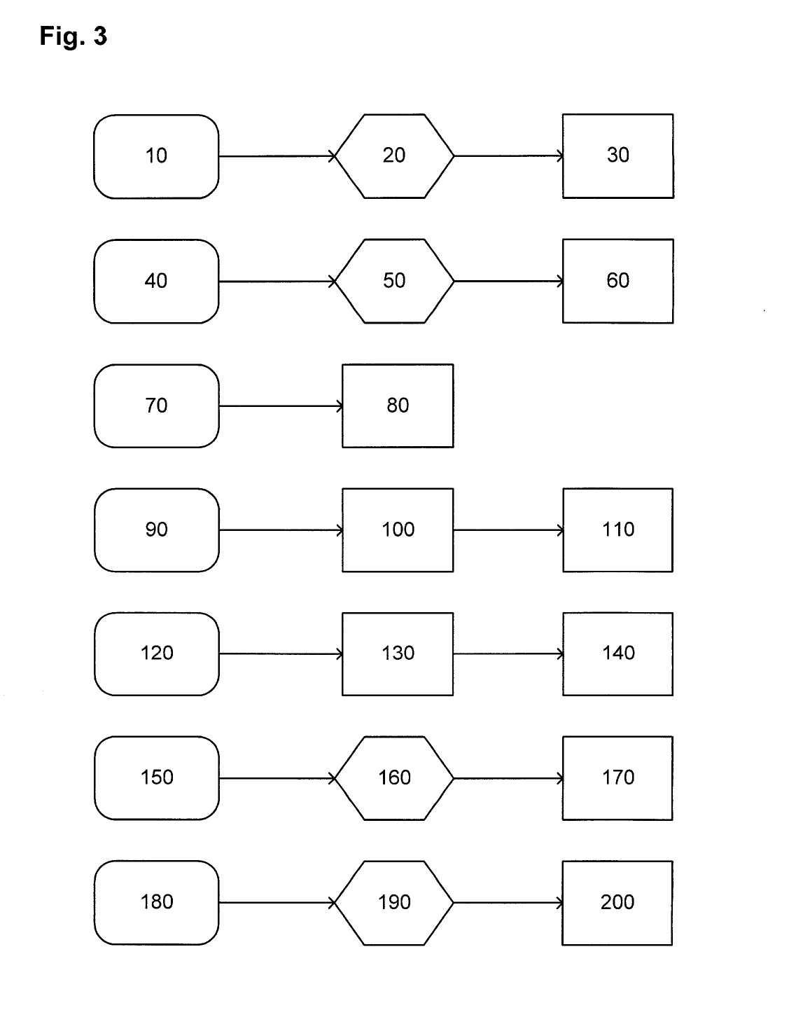

FIG. 3 shows some sample operations which can be performed by the user using the web-enabled personal computer WPC. Rounded rectangular boxes represent actions performed by the user; hexagonal boxes represent HTML forms, and rectangular boxes represent HTML pages. The key to FIG. 3 is as follows:

10: The user adds an item to their list

20: The user adds an item to the form and submits it

30: The updated list is shown with confirmation of the change

40: The user deletes an item from their list

50: The user selects the checkbox of that item and submits the form

60: The updated list is shown with confirmation of the changes

70: The user views their list

80: The current list is displayed

90: The user views recipe instructions

100: The current recipes of the week are shown as links; the user selects a link

110: Ingredients and instructions for the selected recipe are shown

120: The user views instructions for their favorite recipe

130: A favorite recipe list is shown as links; a link is selected

140: Ingredients and instructions for the selected recipe are shown

150: The user adds a current recipe to their favorites list

160: The user selects a current recipe and clicks ‘add to favorites’

170: The updated favorites list is shown with confirmation of the change

180: The user deletes a recipe from the favorites list

190: The user selects a favorite recipe by clicking on a check box and clicking ‘delete’

200: The updated favorites list is shown with confirmation of the change

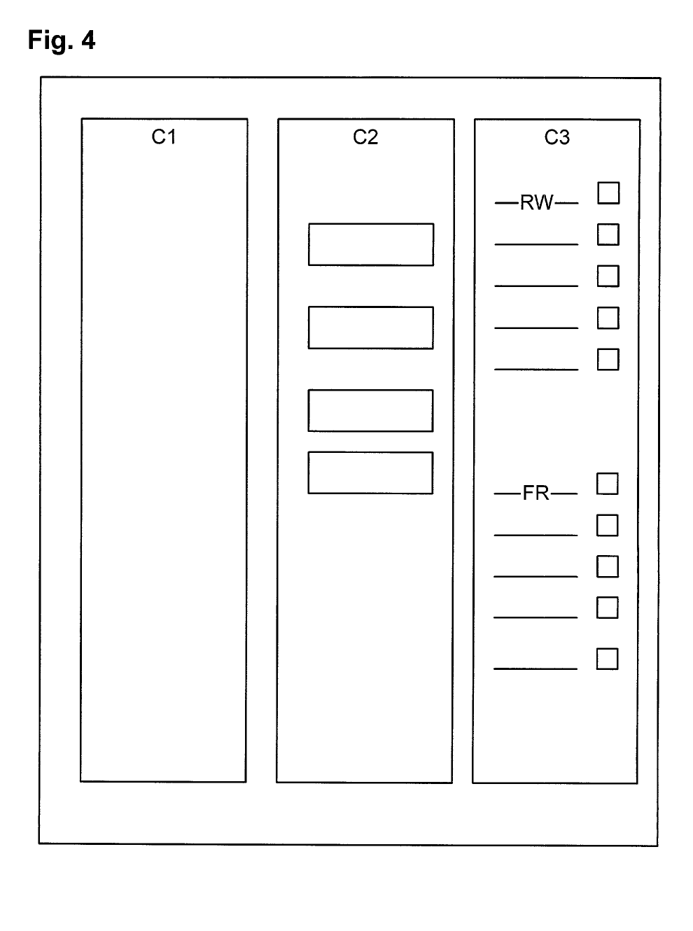

FIG. 4 shows an outline layout of the web page: column C1 displays the user's current list of ingredients, column C2 contains a form allowing items to be added to the list, and column C3 displays current recipes of the week RW and the user's favorite recipes FR.

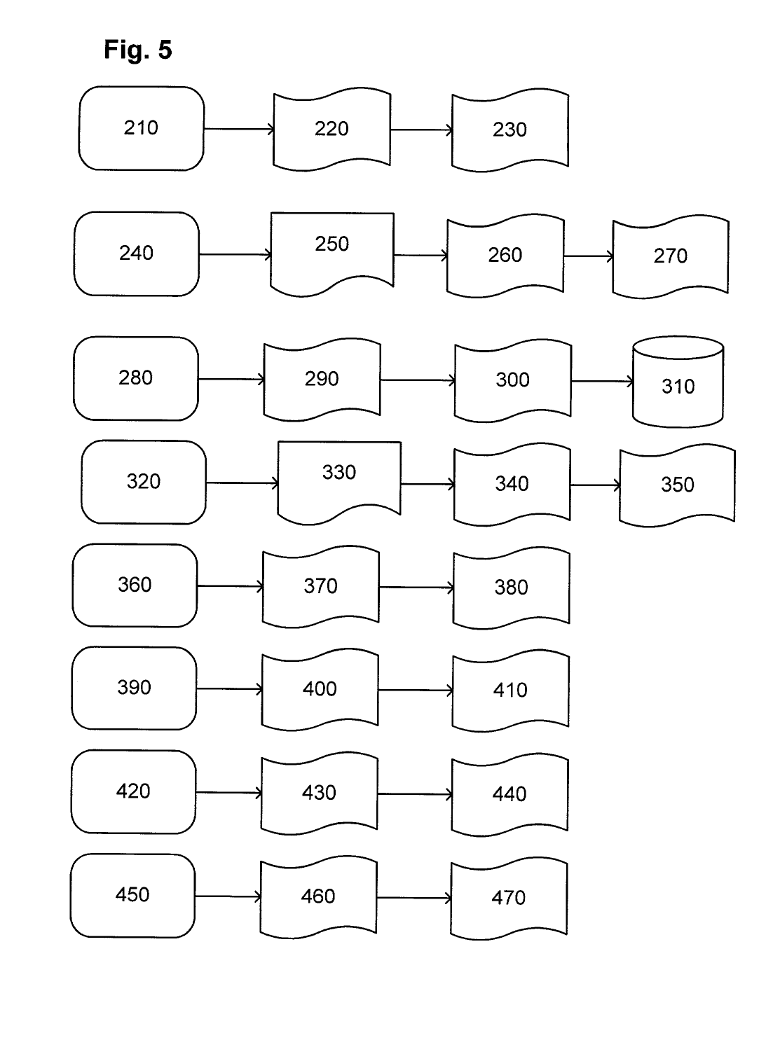

FIG. 5 shows some sample operations which can be performed by the user using the SMS-enabled mobile telephone ST to communicate with the SMS server. Rounded rectangular boxes represent user actions; document boxes represent paper documents; message boxes represent SMS messages; and database boxes represent database actions. The key is as follows:

210: The user adds an item to their list by sending an SMS

220: an SMS message including ‘ADD’ and the list of items is sent

230: the user receives an SMS message confirming the update or signaling an error.

240: The user adds a recipe from a magazine to their list of favorites

250: the user sees the recipe in the magazine with an SMS code and a telephone number

260: the user sends the code to the designated number

270: the user receives an SMS message confirming the update or signaling an error.

280: The user sends an SMS request to view their list

290: the user sends an SMS message containing ‘list’

300: the user receives one or more SMS messages with the list items

310: all the items are removed from the user's database.

320: The user adds an item from a magazine to their list

330: the user sees a magazine advert with an SMS code and a telephone number

340: the user sends an SMS message with the code to the designated number

350: the user receives an SMS message confirming the update or signaling an error.

360: The user requests the ingredients for a recipe of the week;

370: the user sends an SMS message containing a recipe type code: ‘fish’, ‘veg’, ‘meat’, ‘diet’ or ‘chick’

380: the user receives an SMS message with the recipe title and the ingredients.

390: The user sends an SMS message requesting the names of the recipes of the week

400: the user sends an SMS message containing the word ‘recipes’

410: the user receives an SMS message with the recipe titles and their corresponding codes.

420: The user requests the names of this week's recipes

430: The user sends the SMS message ‘favs’

440: The user receives one or more SMS messages with the recipe titles and corresponding letters.

450: The user requests the ingredients of the recipe of the week

460: The user sends an SMS containing the word ‘fav’ and the corresponding letter

470: the user receives one or more SMS messages with the recipe title and ingredients.

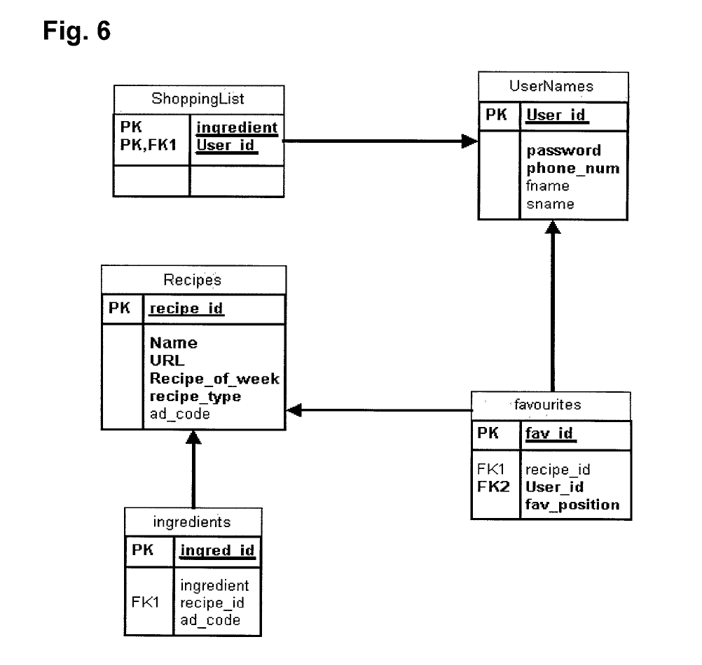

FIG. 6 shows the database schema of the database DB, including primary keys PK and foreign keys FK1, FK2. A ‘ShoppingList’ table contains ingredient fields and a ‘UserID’ field identifying the user. The ‘UserID’ field refers to a ‘UserNames’ table which contains, for each UserID, the password and mobile phone number (‘phone_num’) and optionally the first name (‘fname’) and surname (‘sname’). A ‘favorites’ table contains a favorites identity field (‘fav_id’) as the primary key, a recipe identity field (‘recipe_id’) which refers to a ‘Recipes’ field, a user ID field (‘User_id’) which identifies the user to whom the recipes relate, and a favorites position field (‘fav_position’) which stores the order in which the recipe should be ranked. A ‘Recipes’ table contains a recipe ID (‘recipe_ID’) field as the primary key, and fields which indicate the name, URL which links for example to a demonstration of the recipe, whether that recipe is recipe of the week, the recipe type of the recipe, and an ‘ad’ code which is the advertised code used to add the recipe to a user's database. An ‘Ingredients’ table contains an ingredient identity field (‘ingredient_id’) as the primary key, and fields indicating the name of the ingredient, the recipes in the recipe table which use that ingredient, and an ‘ad’ code which is the advertised code used to add the ingredient to a user's personal database.

The database is able to run at least the following procedures:

1) Add an ingredient to a user's shopping list given the name of the ingredient and the user ID.

2) Add an ingredient to a user's shopping list given the ‘ad’ code of the ingredient and the user ID.

3) Add a recipe ID from the recipe table to the favorites list for a specified user.

4) Add a list of ingredients to the user's shopping list, given a recipe ID and the user ID.

5) Check a given user ID and password against a stored user ID and password and indicate whether they match.

6) Delete a specified ingredient from a user's shopping list.

7) Delete a specified recipe from a user's list of favorites.

8) Return the list of ingredients for a recipe specified by a position in the user's favorites list.

9) Return the list of ingredients for a recipe specified by an ‘ad’ code.

10) Return the name of a recipe at a given position of the user's list of favorites.

11) Return the user ID for a given phone number.

12) Return the list of favorites for a given user.

13) Return a list of the current recipes of the week.

14) Return the list of ingredients in the user's shopping list. The database functions may be stored as SQL code on the database server, and the SQL code may be stored on a suitable carrier, such as a floppy disc or CD-R, or carried on an electronic communications signal for loading onto the database server.

The SMS server can use any suitable programming language, such as a server-side Common Gateway Interface (“CGI”) language (e.g., Perl scripts) to process the data received via SMS and to send an SMS in response, if required. The Perl scripts may be stored on a suitable carrier, such as a floppy disc or CD-R, or carried on an electronic communications signal for loading onto the SMS server. The Perl scripts can perform actions including the following:

1) When a request for a user's shopping list is received, query the database to find that user's list and send an SMS containing that list. If the list exceeds 160 characters in length, the data is split across multiple messages.

2) Add an item to a user's shopping list.

3) Return the user's favorite recipes via SMS.

4) Return the recipes of the week via SMS.

5) Return lists of ingredients for a favorite recipe or recipe of the week, via SMS.

6) Add an ingredient to the user's shopping list or a recipe to the user's favorites according to an ‘ad’ code received via SMS.

The method in accordance to various embodiments of the present invention can be implemented using instructions that are stored in memory coupled to a processor. The instructions are adapted to be executed on the processor. A processor can be a general purpose microprocessor, such as the Intel Pentium III processor, manufactured by the Intel Corporation of Santa Clara, California. A processor can also be an Application Specific Integrated Circuit (“ASIC”) that embodies at least part of the method in accordance with an embodiment of the present invention in its hardware and/or firmware. An example of an ASIC is a digital signal processor. Likewise, a processor can be a combination of one or more general purpose microprocessors and/or ASICs.

Memory can be any device adapted to store electronic information, such as Read Only Memory (“ROM”), Random Access Memory (“RAM”), a hard disk, a floppy disk, a CD-ROM, flash memory, etc., or a combination thereof At least part of the memory should be writeable as well as readable.

In one embodiment, the instructions are adapted to be executed on a processor to store and retrieve one or more items on a database over more than one communications network. The instructions can receive over a first network a first data item along with a first user identity code from a first communications terminal; receive over a second network a retrieval request along with a second user identity code from a second communications terminal; determine the retrieval request is authentic and/or authorized, and if so, send a data item to the second communications terminal. An example of a user identity code is the wireless cellular telephone number of the cell phone from which information (e.g., a data item, retrieval request, etc.) is sent. These instructions can be stored in a single memory and be implemented at a single site on a single processor, or else be stored and implemented in a distributed fashion over several memories and processors, respectively.

The instructions for performing the method in accordance with an embodiment of the present invention can be stored and distributed on any medium capable of storing information, such as a CD-ROM, a floppy disk, portable flash memory, etc. Alternatively, the instructions can be distributed electronically (e.g., online, over a network from a server to a client.) The above embodiments are described purely by way of example and modifications may be made without departing from the spirit and scope of the present invention. For example, SMS, WAP, internet and interactive TV protocols and networks may be replaced by other protocols and networks which nevertheless provide similar or improved functionality. Alternatively, aspects of the present invention may be performed using a single network and set of protocols which combine some or all of the features of the different networks and protocols described above. Further, identifying and/or authenticating the source of a data item or a retrieval request need not require the matching (exact or otherwise) of the user identity codes. Any other suitable method of identification, authenticating, and/or determining the authorization of a source can be used. For example, methods known by those of ordinary skill in the art involving digital signatures can be employed, e.g., using public key encryption technology. Also, embodiments of the present invention may be applied to environments other than shopping environments.

What is claimed is:

1. A method of storing and retrieving one or more items on a database over a plurality of communications networks, including:
a. entering, at a first communications terminal, one or more data items;
b. transmitting said data items, together with a first user identity code, to a database server over a first communications network;
c. transmitting a retrieval request, together with a second user identity code, from a second, wireless communications terminal to said database server over a second, wireless communications network; and,
d. if said first user identity code matches said second user identity code, receiving at least some of said one or more data items.

2. A method according to claim 1, wherein steps a and b comprise the steps of:
i. entering, at said first communications terminal, one or more first data items;
ii. transmitting said one or more first data items, together with said first user identity code, to the database server over the first communications network;
iii. entering, at said first communications terminal, one or more second data items; and
iv. transmitting said one or more second data items, together with said first user identity code, to the database server over the first communications network.

3. A method of storing and retrieving one or more data items on a database, including:
a. receiving, from a first communications terminal, a set of data items and a first user identity code;
b. indexing said data items on said database according to said first user identity code;
c. receiving a retrieval request and a second user identity code from a second, wireless communications terminal;
d. matching said second user identity code to said first user identity code;
e. retrieving at least some of said data items corresponding to the first user identity code; and
f. transmitting said retrieved data items to said second, wireless communications terminal.

4. A method according to claim 3, wherein steps a and b comprise the steps of:
i. receiving over the first communications network from said first communications terminal, one or more first data items together with said first user identity code;
ii. indexing said one or more first data items on said database according to said first user identity code;
iii. receiving over the first communications network from said first communications terminal one or more second data items together with said first user identity code; and
iv. indexing said one or more second data items on said database according to said first user identity code.

5. Apparatus for storing and retrieving data items, comprising:
a. a database; and
b. a plurality of different communication channel interfaces for providing an interface between the database and a respective plurality of different communication channel types, including one or more wireless channel types;
whereby each of a plurality of users is enabled to transmit one or more data items for storage on the database via any of the communication channel interfaces and to retrieve said one or more data items via any of the communication channel interfaces.

6. A method of retrieving information from a database over one or more communications networks, including:
a. entering a code at a wireless communications terminal,
b. transmitting said code over a wireless communications network to a database server; and
c. receiving from said database server, in response to said code, a set of data items derived from said code.

7. A method according to claim 6, wherein said code is displayed in the vicinity of the wireless communications terminal.

8. A method of adding data items to a data record, including:
a. storing data set records each including a data code and a set of data items;
b. receiving a data code and a user identity code from a wireless communications terminal over a wireless communications network;
c. retrieving one of said data set records corresponding to said received data code; and
d. adding the set of data items from said retrieved data set record to a user data record indexed according to said received user identity code.

9. A method according to claim 8, wherein said data code is displayed in the vicinity of the wireless communications terminal.

10. A method of retrieving information from a database over one or more communications networks, including:
a. storing a plurality of sets of data and corresponding set identity codes;
b. receiving a set identity code over a wireless communications network from a first wireless communications terminal;
c. retrieving one of said sets of data from the database corresponding to said set identity code; and
d. transmitting said set of data to said first communications terminal or to a second communications terminal.

11. A method according to claim 10, wherein the set of data is transmitted to said second communications terminal.

12. A method according to claim 11, wherein the second communications terminal is a fixed terminal.

13. A method according to claim 11, wherein the second communications terminal transmits said set of data to said first, wireless communications terminal or to a third, wireless communications terminal.

14. A method according to claim 11, wherein said first wireless communications terminal transmits a first user identity code and the second communications terminal receives a second user identity code, and said set of data is retrieved if said first user identity code matches said second user identity code.

15. A method according to claim 14, wherein said second communications terminal reads said second user identity code from a portable token.

16. A method according to claim 10, wherein said set code is displayed in the vicinity of the first wireless communications terminal.

17. A method according to claim 10, wherein said set of data includes an alphanumeric list of items.

18. A method according to claim 6, wherein said set of data includes one or more video clips.

19. A system for retrieving sets of data items, comprising:
a. a database storing a plurality of sets of data items and corresponding set codes;
b. at least one communication channel interface for providing an interface between the database and a corresponding communication network; and
c. at least one user terminal for communication over said communication network;
wherein the communication channel interface is arranged to receive a set code from the at least one user terminal, to match the set code to a set code in the database and to transmit the corresponding set of data items to the user terminal.

20. A system for storing sets of data items, comprising:
a. a first database storing a plurality of sets of data items and corresponding set codes;
b. a second database storing sets of data items indexed by user;
c. at least one communication channel interface for providing an interface between the database and a corresponding communication network; and
d. a plurality of user terminals for communication over said communication network;
wherein the communication channel interface is arranged to receive a set code and a user identity code from one of said user terminals, to match the set code to a set code in the first database and to store the corresponding set of data items in the second database, indexed according to the user identity code.

21. A method of retrieving and transmitting information, including:
a. receiving a variable code and a user identity code over a wireless communications network from a wireless communications terminal;
b. retrieving, in response to receipt of said variable code, a data record corresponding to the user identity code; and
c. transmitting said data record to a data receiver other than the wireless communications terminal.

22. A method according to claim 21, including selecting said data receiver from a plurality of data receivers according to said variable code.

23. A method according to claim 21, further including conducting a transaction between the user of the wireless communication terminal and the selected data receiver.

24. A method according to claim 21, wherein said variable code is displayed in the vicinity of the wireless communications terminal.

25. A computer program arranged to perform a method according to claim 21.

26. A carrier bearing a computer program according to claim 25.
